(19) United States
(12) Patent Application Publication
(10) Pub. No.: US 2015/0326998 A1
(43) Pub. Date: Nov. 12, 2015

(54) Pre-Configuration of Devices Supporting National Security and Public Safety Communications

(71) Applicant: Telefonaktiebolaget L M Ericsson (publ), Stockholm (SE)

(72) Inventors: Stefan Wänstedt, Lulea (SE); Fredrik Gunnarsson, Linköping (SE); Bengt Lindoff, Bjarred (SE)

(21) Appl. No.: 14/423,460

(22) PCT Filed: Jan. 20, 2015
(86) PCT No.: PCT/SE2015/050047

§ 371 Date: Feb. 24, 2015

Related U.S. Application Data
(60) Provisional application No. 61/933,445, filed on Jan. 30, 2014.

(51) Int. Cl. H04W 4/00; H04B 1/3816; H04W 76/02; H04W 4/08; H04W 76/04; H04W 4/02; H04L 12/24

(52) U.S. Cl. CPC H04W 4/008; H04W 4/02; H04B 1/3816; H04L 41/0806; H04W 4/08; H04W 76/048; H04W 76/023; H04W 84/12

(57) ABSTRACT

Configuration information for out-of-coverage D2D operation is transferred to each of one or more mobile terminals prior to their use in D2D communications and, more specifically, prior to their use in an out-of-coverage D2D mode. Example embodiments of the presently disclosed techniques include methods implemented in a mobile terminal adapted for operating a wide-area wireless network, such as an LTE network, and further adapted to operate in a D2D mode. One such method comprises obtaining configuration information for out-of-coverage device-to-device, D2D, operation, determining that no wide-area wireless network is available for communicating, and, in response to this determining, initiating monitoring of resources or transmission using resources, or both, according to the obtained configuration information.

### TECHNICAL FIELD

The technology disclosed herein relates generally to wireless communication networks, and more particularly relates to techniques for wireless device-to-device communications.

### BACKGROUND

Device-to-device (D2D) communication is a well-known and widely used component of many existing wireless technologies, including ad hoc and cellular networks. Examples include Bluetooth and several variants of the IEEE 802.11 standards suite, such as WiFi Direct. These example systems operate in unlicensed spectrum.

Although the idea of enabling D2D communications as a means of relaying in cellular networks was proposed by some early works on ad hoc networks, the concept of allowing local D2D communications to (re)use cellular spectrum resources simultaneously with ongoing cellular traffic is relatively new. Because the non-orthogonal resource sharing between the cellular and the D2D layers has the potential of reuse gain and proximity gain, along with increased resource utilization, the concept of D2D communications underlying cellular networks has received considerable interest in recent years.

The Third Generation Partnership Project (3GPP) refers to Network Controlled D2D as “Proximity Services” or “ProSe,” and efforts aimed at integrated D2D functionality into the Long Term Evolution (LTE) specifications are underway. The ProSe Study Item (SI) recommends supporting D2D operation between wireless devices-referred to as user equipments or UEs by the 3GPP—that are out of network coverage, and between in-coverage and out-of-coverage wireless devices. In such cases, certain UEs may regularly transmit synchronization signals to provide local synchronization to neighboring wireless devices.

Specifically, in 3GPP LTE networks, such LTE Direct D2D communication can be used in commercial applications, such as cellular network offloading, proximity based social networking. D2D communications involving out-of-coverage operation are expected to be particularly important in so-called national security and public safety services (NSPS), such as in public safety situations in which first responders need to communicate with each other and with people in a disaster area. Both commercial and public safety applications are among the use cases discussed in the feasibility study performed by members of the 3^{rd}-Generation Partnership Project (3GPP) and documented in the report “3^{rd} Generation Partnership Project; Technical Specification Group Services and System Aspects; Feasibility study for Proximity Services (ProSE),” 3GPP TR 22.803, v. 12.2.0 (June 2013), available at www.3gpp.org.

D2D communication entities using an LTE Direct link may reuse the same physical resource blocks (“PRBs,” the basic time-frequency resource in the LTE radio link) as used for cellular communications either in the downlink or in the uplink or both. The reuse of radio resources in a controlled fashion can lead to the increase of spectral efficiency at the expense of some increase of the intra-cell interference.

Typically, D2D communicating entities in an LTE-underlying scenario will use uplink (UL) resources, such as UL PRBs or UL time slots, but conceptually it is possible that D2D (LTE Direct) communications takes place in the cellular downlink (DL) spectrum or in DL time slots. For ease of presentation, in the present disclosure it is assumed that D2D links use uplink resources, such as uplink PRBs in a Frequency-Division Duplexing (FDD) LTE system, or uplink time slots in an a cellular Time-Division Duplexing (TDD) system, but the essential ideas disclosed herein may be readily applied to cases in which D2D communications take place in DL spectrum as well.

### SUMMARY

D2D communications involving out-of-coverage operation are expected to be particularly important in national security and public safety services (NSPS), such as in public safety situations in which first responders need to communicate with each other and with people in a disaster area.

For public safety applications, it is important for devices to work even if there is no LTE network, for some reason. The LTE network may be missing, for example, due to a rescue site being very remote, or due to a natural disaster, such as a typhoon. Prior to communicating in such an out-of-coverage situation, the D2D devices must be configured, so that each knows what resources to use, and how to use them. However, if there is no LTE network available from which the devices can receive configuration information, some other means to configure the devices are needed.

In several embodiments of the presently disclosed techniques and apparatus, configuration information for out-of-coverage D2D operation is transferred to each of one or more mobile terminals prior to their use in D2D communications and, more specifically, prior to their use in an out-of-coverage D2D mode. In some embodiments, the transferred configuration information includes detailed and specific configuration information, including any or several of the various D2D operating parameters described below. In other embodiments, a configuration identifier, such as an index or pointer to one or more pre-stored configurations, is transferred to the UE instead.

Example embodiments of the presently disclosed techniques include methods implemented in a mobile terminal adapted for operating a wide-area wireless network, such as an LTE network, and further adapted to operate in a D2D mode. One such method comprises obtaining configuration information for out-of-coverage device-to-device, D2D, operation, determining that no wide-area wireless network is available for communicating, and, in response to this determining, initiating monitoring of resources or transmission using resources, or both, according to the obtained configuration information.

In some embodiments, the obtaining is performed without the use of a wide-area wireless network, e.g., by receiving the configuration information via a connector interface on the mobile terminal, such as from a Universal Serial Bus (USB) device. Other examples include receiving the configuration information via a wireless local-area network, obtaining the configuration information from a subscriber identifier module (SIM) attached to or associated with the mobile terminal, receiving the configuration information over a short-range wireless connection, such as over a Bluetooth link, receiving the configuration information using near-field communications (NFC) technology, such as from a Radio-Frequency Identification (RFID) device, receiving the configuration information by observing a visual representation of the configuration information, using a camera, receiving the configuration information via human interface interaction, and receiving the configuration information via a memory card. In some embodiments, obtaining configuration information comprises determining a position for the mobile terminal and determining the configuration information from the position.

In some embodiments, obtaining configuration information comprises obtaining one or more D2D configuration parameters defining out-of-coverage D2D operation. In some other embodiments, obtaining configuration information comprises obtaining a configuration identifier and retrieving one or more D2D configuration parameters from one of two or more stored configurations, using the obtained configuration identifier. In either case, the one or more D2D configuration parameters may comprise one or more of the following, in various embodiments: details of resources allocated for D2D transmission; identification of resources for one or more of synchronization signal transmission, broadcast information transmission, discovery signal transmission, scheduling assignment transmission, and payload data transmission; discontinuous receive, DRX, settings and/or discontinuous transmit, DTX, settings; incident manager identifiers; and D2D group information.

Other embodiments, detailed below, include wireless device apparatus configured to carry out one or more of the methods summarized above, or variants thereof, as well as corresponding computer program products and computer-readable media.

### BRIEF DESCRIPTION OF THE DRAWINGS

FIG. 1 is a schematic diagram illustrating a portion of an example Long-Term Evolution (LTE) network.

FIG. 2 is a block diagram illustrating features of an example wireless device according to some embodiments of the presently disclosed techniques and apparatus.

FIG. 3 illustrates in-network and out-of-network scenarios for D2D communication.

FIG. 4 is a process flow diagram illustrating an example method according to some of the disclosed techniques.

FIG. 5 is a process flow diagram illustrating another example method according to some of the disclosed techniques.

FIG. 6 illustrates an example of the D2D resource components, as mapped to an illustrative time-frequency grid of resources.

FIG. 7 is a block diagram illustrating another representation of a wireless device configured to carry out one or more of the disclosed techniques.

### DETAILED DESCRIPTION

Inventive concepts will now be described more fully hereinafter with reference to the accompanying drawings, in which examples of embodiments of inventive concepts are shown. These inventive concepts may, however, be embodied in many different forms and should not be construed as limited to the embodiments set forth herein. Rather, these embodiments are provided so that this disclosure will be thorough and complete, and fully convey the scope of present inventive concepts to those skilled in the art. It should also be noted that these embodiments are not mutually exclusive. Components from one embodiment may be tacitly assumed to be present or used in another embodiment.

For purposes of illustration and explanation only, some embodiments of the present inventive concepts are described herein in the context of operating in or in association with a Radio Access Network (RAN) that communicates over radio communication channels with mobile terminals (also referred to as wireless terminals or UEs).

In some embodiments of a RAN, several base stations may be connected (e.g., by landlines or radio channels) to a radio network controller (RNC). A radio network controller, also sometimes termed a base station controller (BSC), may supervise and coordinate various activities of the plural base stations connected thereto. A radio network controller may be connected to one or more core networks. According to some other embodiments of a RAN, base stations may be connected to one or more core networks without a separate RNC(s) between, for example, with functionality of an RNC implemented at base stations and/or core networks.

As used herein, the terms “mobile terminal,” “wireless terminal,” “user equipment,” or “UE” may be used to refer to any device that receives data from and transmits data to a communication network, any of which may be for example, a mobile telephone (“cellular” telephone), laptop/portable computer, pocket computer, hand-held computer, desktop computer, a machine to machine (M2M) or MTC type device, a sensor with a wireless communication interface, etc. Devices of any of these types may be adapted, according to known techniques and according to the additional techniques disclosed herein, for operation in a device-to-device (D2D) mode, where such operation may include the transmitting and receiving of certain signals that are similar to or identical with corresponding signals used when operating within a cellular network, i.e., in a device-to-base-station operating mode.

Note that although terminology from specifications for the Long-Term Evolution (LTE; also referred to as the Evolved Universal Terrestrial Radio Access Network, or E-UTRAN and or the Universal Mobile Telecommunications System (UMTS) is used in this disclosure to exemplify embodiments of the inventive concepts, this should not be seen as limiting the scope of the presently disclosed techniques to only these systems. Devices designed for use in other wireless systems, including variations and successors of 3GPP LTE and WCDMA systems, WiMAX (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of present inventive concepts disclosed herein.

Also note that terminology such as base station (also referred to as NodeB, eNodeB, or Evolved Node B) and wireless terminal or mobile terminal (also referred to as User Equipment node or UE) should be considered non-limiting and does not imply a certain hierarchical relation between the two. In general, a base station (e.g., a “NodeB” or “eNodeB”) and a wireless terminal (e.g., a “UE”) may be considered as examples of respective different communications devices that communicate with each other over a wireless radio channel.

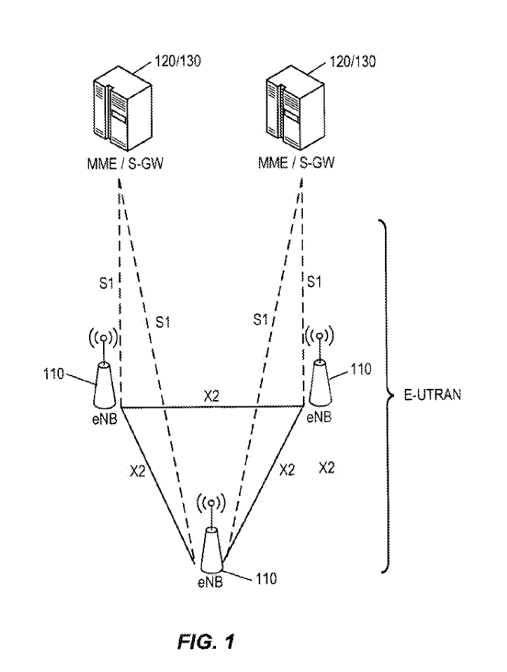

The Evolved UMTS Terrestrial Radio Access Network (E-UTRAN) includes base stations called enhanced NodeBs (eNBs or eNodeBs), providing the E-UTRA user plane and control plane protocol terminations towards the UE. The eNBs are interconnected with each other using the X2 interface. The eNBs are also connected using the S1 interface to the EPC (Evolved Packet Core), more specifically to the MME (Mobility Management Entity) by means of the S1-MME interface and to the Serving Gateway (S-GW) by means of the S1-U interface. The S1 interface supports many-to-many relation between MMEs/S-GWs and eNBs. A simplified view of the E-UTRAN architecture is illustrated in FIG. 1.

The eNB 110 hosts functionalities such as Radio Resource Management (RRM), radio bearer control, admission control, header compression of user plane data towards serving gateway, and/or routing of user plane data towards the serving gateway. The MME 120 is the control node that processes the signaling between the UE and the CN (core network). Significant functions of the MME 120 are related to connection management and bearer management, which are handled via Non Access Stratum (NAS) protocols. The S-GW 130 is the anchor point for UE mobility, and also includes other functionalities such as temporary DL (down link) data buffering while the UE is being paged, packet routing and forwarding to the right eNB, and/or gathering of information for charging and lawful interception. The PDN Gateway (P-GW, not shown in FIG. 1) is the node responsible for UE IP address allocation, as well as Quality of Service (QoS) enforcement (as further discussed below). The reader is referred to 3GPP TS 36.300 and the references therein for further details of functionalities of the different nodes.

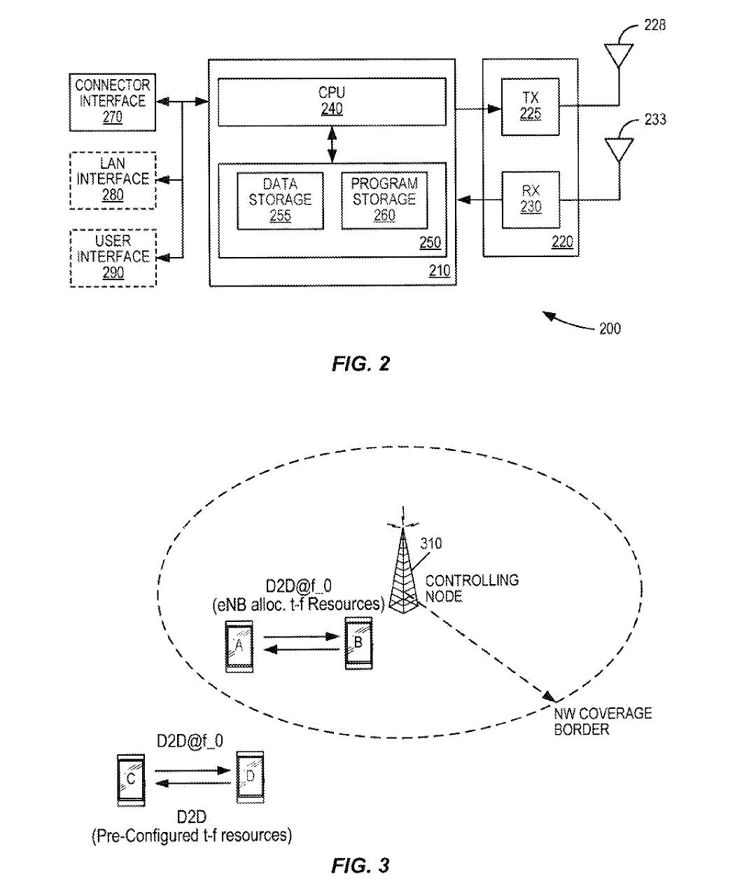

Several of the techniques and methods described herein are implemented using radio circuitry, electronic data processing circuitry, and other electronic hardware provided in a mobile terminal. FIG. 2 illustrates features of an example mobile terminal 200 according to several embodiments of the present invention. Mobile terminal 200, which may be a UE configured for operation with an LTE wireless communication network (E-UTRAN), for example, as well as for operation in a device-to-device mode, comprises a radio transceiver circuit 220 configured to communicate with one or more base stations as well as a processing circuit 210 configured to process the signals transmitted and received by the transceiver unit 220. Transceiver circuit 220 includes a transmitter 225 coupled to one or more transmit antennas 228 and receiver 230 coupled to one or more receiver antennas 233. The same antenna(s) 228 and 233 may be used for both transmission and reception, in some embodiments.

Receiver 230 and transmitter 225 use known radio processing and signal processing components and techniques, typically according to a particular telecommunications standard such as the 3GPP standards for LTE. Note also that transmitter circuit 220 may comprise separate radio and/or baseband circuitry for each of two or more different types of radio access network, in some embodiments. The same applies to the antennas—while in some cases one or more antennas may be used for accessing multiple types of networks, in other cases one or more antennas may be specifically adapted to a particular radio access network or networks. Because the various details and engineering tradeoffs associated with the design and implementation of such circuitry are well known and are unnecessary to a full understanding of the invention, additional details are not shown here.

Processing circuit 210 comprises one or more processors 240 coupled to one or more memory devices 250 that make up a data storage memory 255 and a program storage memory 260. Processor 240, identified as CPU 240 in FIG. 2, may be a microprocessor, microcontroller, or digital signal processor, in some embodiments. More generally, processing circuit 210 may comprise a processor/firmware combination, or specialized digital hardware, or a combination thereof. Memory 250 may comprise one or several types of memory such as read-only memory (ROM), random-access memory, cache memory, flash memory devices, optical storage devices, etc. Because terminal 200 may support multiple radio access networks, including, for example, a wide-area RAN such as LTE as well as a wireless local-area network (WLAN), processing circuit 210 may include separate processing resources dedicated to one or several radio access technologies, in some embodiments. Again, because the various details and engineering tradeoffs associated with the design of baseband processing circuitry for mobile devices are well known and are unnecessary to a full understanding of the invention, additional details are not shown here.

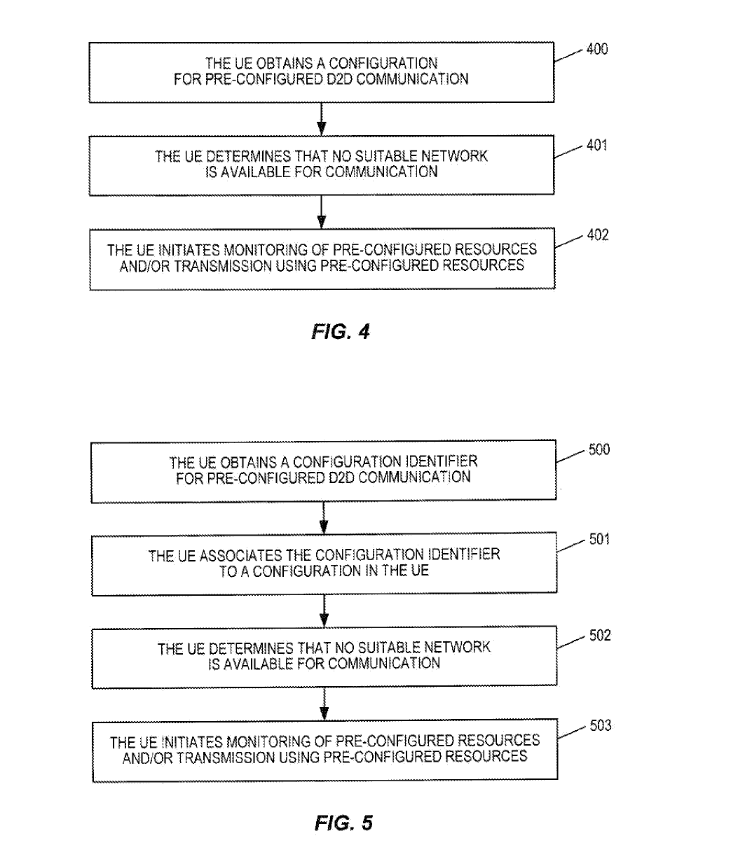

Typical functions of the processing circuit 210 include modulation and coding of transmitted signals and the demodulation and decoding of received signals. In several embodiments of the present invention, processing circuit 210 is adapted, using suitable program code stored in program storage memory 260, for example, to carry out one of the techniques specifically described herein, including, for example, one or more of the methods illustrated in FIGS. 4 and 5 and variants thereof. Of course, it will be appreciated that not all of the steps of these techniques are necessarily performed in a single microprocessor or even in a single module.

Mobile terminal 200 may further include one or more additional interface circuits, depending on the specific application for the unit. Typically, mobile terminal 270 includes connector interface circuitry 270. In some embodiments, connector interface circuitry 270 may consist of no more than terminals and associated hardware to support charging of an on-board battery (not shown) or to provide direct-current (DC) power to the illustrated circuits. More often, connector interface circuitry 270 further includes a wired communication and/or control interface, which may operate according to proprietary signaling and message formats in some embodiments, or according to a standardized interface definition, in others. For example, connector interface 270 may comprise terminals and associated hardware for support of the well-known Universal Serial Bus (USB) interface. It will be appreciated that while connector interface circuitry 270 includes at least the necessary receiver and driver circuits to support such an interface and may further comprise specialized hardware/firmware, part of the interface functionality may be provided by CPU 240, configured with appropriate firmware and/or software in memory 250, in some embodiments.

Mobile terminal 200 may further comprise local-area network (LAN) interface circuitry 280, in some embodiments. In some embodiments, for example, LAN interface circuitry 280 may provide support for wireless LAN (WLAN) functionality, such as according to the well-known Wi-Fi standards. In some such embodiments, LAN interface circuitry 280 may include an appropriate antenna or antennas. In other embodiments, LAN interface circuitry 280 may make use of one or more common antenna structures that provide reception and/or transmission of WLAN signals as well as wide-area RAN signals. In some embodiments, LAN interface circuitry 280 may be relatively self-contained, in that it includes all of the necessary hardware, firmware, and/or software to carry out the LAN functionality, including the associated protocol stacks. In other embodiments, at least parts of the LAN functionality may be carried out by processing circuit 210.

Still further, mobile terminal 200 may include user-interface circuitry 290, which may include, for example, circuitry and/or associated hardware for one or more switches, pushbuttons, keypads, touch screens, and the like, for user input, as well as one or more speakers and/or displays for output. Of course, some mobile terminal's, such as those developed for machine-to-machine applications or for insertion into another device (e.g., a laptop computer) may have only a subset of these input/output devices, or none at all.

As discussed above, 3GPP is developing specifications for proximity services, often referred to as “ProSe,” which include specifications for device-to-device (D2D) operation utilizing the same time-frequency resources used by LTE networks, in each of several possible operating modes that include in-coverage operation (where the involved D2D devices are all within the coverage area of an LTE network), out-of-coverage operation (where none of the devices are within the coverage area of an LTE network), and combinations of both. As noted above, D2D communications involving out-of-coverage operation are expected to be particularly important in so-called national security and public safety services (NSPS), such as in public safety situations in which first responders need to communicate with each other and with people in a disaster area.

FIG. 3 illustrate basic principles for D2D communication within LTE, for both in-coverage and out-of-coverage scenarios. A controlling node, e.g., an eNode B or a Cluster Head (a node controlling access to a cluster of D2D terminals), controls the communication on a frequency carrier f_{—}0. In a first scenario, devices A and B are communicating directly via a D2D link, and both devices are inside network (NW) coverage of the controlling node. The controlling node then allocates the radio resources to devices A and B use for use in D2D communication. In the second scenario, devices C and D may have D2D communication out of reach from a controlling node, i.e., out of coverage. In this case the D2D communication devices are using pre-configured time-frequency (t-f) resources for D2D communication. The pre-configuration of these resources may be by standard, for example. In some cases, the pre-configuration of these resources may depend on the device's capabilities. For example, one device might be categorized as an NSPS type 1 device, for police use, while another is categorized as an NSPS type 2 device, for military use. The pre-configuration of these different devices may then differ, depending on their respective capabilities.

For public safety applications, it is important for devices to work even if there is no LTE network, for some reason. The LTE network may be missing, for example, due to a rescue site being very remote, or due to a natural disaster, such as a typhoon. Prior to communicating in such an out-of-coverage situation, the D2D devices must be configured, so that each knows what resources to use, and how to use them. However, if there is not LTE network available from which the devices can receive configuration, some other means to configure the devices are needed.

According to several embodiments of the presently disclosed techniques and apparatus, then, one or more of various means are employed, prior to engaging in D2D communication, to configure a mobile terminal for ProSe communication. In some embodiments, these means provide for mobile terminal D2D operation that is aligned with regulations that are particular to the area or region where the UE will operate.

In several embodiments, configuration information for out-of-coverage D2D operation is transferred to each of one or more mobile terminals prior to their use in D2D communications and, more specifically, prior to their use in an out-of-coverage D2D mode. In some embodiments, the transferred configuration information includes detailed and specific configuration information, including any or several of the various D2D operating parameters described below. In other embodiments, a configuration identifier, such as an index or pointer to one or more pre-stored configurations, is transferred to the UE instead.

FIG. 4 illustrates an example process according to some embodiments of these techniques. As shown at block 400, the illustrated process begins with the UE (or other mobile terminal) obtaining a configuration for pre-configured D2D communication. As just mentioned, this may comprise obtaining one or several specific D2D operating parameters, in some embodiments, or simply obtaining an index to a pre-stored configuration, in others.

As shown at block 401, the UE subsequently determines that no suitable network is available for communication. In response, the UE begins monitoring of resources according to the obtained configuration, or begins transmitting on resources according the obtained configuration, or both, as shown at block 402. In some embodiments, the UE determines that no suitable network is available by evaluating one or more metrics, and determining that the UE is out-of-coverage based on the metric evaluation. Example metrics that might be used for this purpose include:
metrics associated with a DL broadcast channel from a controlling node;
metric associated with DL Synchronization signal/pilot signals from controlling node;
metric Associated with UL coverage—reception of Random Access Response or RRC connection establishment;
metric based on UL sensing.

One possible approach to pre-configuring a UE for out-of-coverage D2D operation is to transfer the configuration information via the wide-area wireless network, when the D2D UE is powered on and in network coverage. However, this may not always be possible. Thus, one possible approach to transferring the configuration information to the UE, without a need for wide-area network coverage, is to use a USB charger or other connector interface to transfer configuration information to the UE, without connecting to the wide-area network. This may be advantageous in many scenarios, since all UEs need to be charged prior to use in any case. Another possible approach is to use a non-LTE network to transfer the configuration to the UE. For example, a WLAN could be used to transfer configuration information to the mobile terminals, via an on-board WLAN transceiver.

FIG. 5 is a process flow diagram illustrating a more detailed procedure, in which a configuration identifier is transferred to the UE, rather than more detailed configuration information.

As shown at block 500, the illustrated method begins with the obtaining, by the UE, of a configuration identifier for pre-configured D2D communication. The UE then associates the configuration identifier to a pre-stored configuration in the UE, as shown at block 501. Subsequently, the UE determines that no suitable network is available for communication, and initiates monitoring of pre-configured D2D resources, or begins transmitting on resources according the obtained configuration, or both, as shown at blocks 502 and 503.

### Configuration Scope

The configuration required for a D2D device to operate in an out-of-coverage mode is a bit more detailed than just information identifying the operating spectrum or specific time-frequency resources. Examples of configuration information needed may include, for example, specific details of the D2D resource pool(s), discontinuous receive/transmit (DRX/DTX) settings, group information (in case there are more than one groups working in the area), incident manager identifiers, frequency/time allocations to be used by the different groups, etc. Several of these configuration parameters are described below. It should be appreciated that transferring configuration information to a mobile terminal according to any of the various techniques described herein may include transferring specific values or indicators for any one or more of these parameters, or transferring an index or other pointer identifying pre-stored values for any one or more of these parameters, or a combination of both approaches.

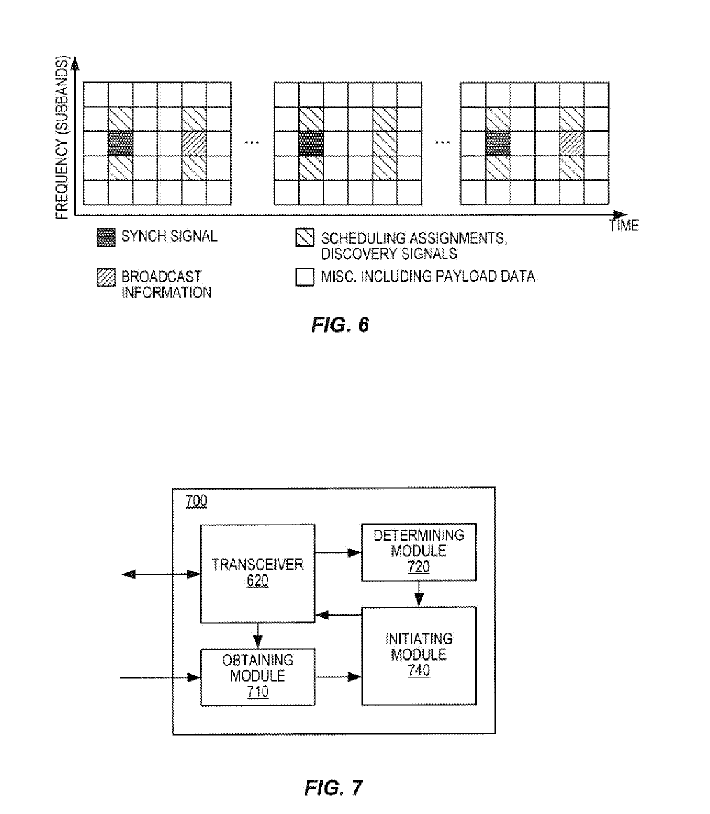

D2D Resource Pool(s)—In general, the D2D resources concern the resources that are allocated for D2D transmission. The D2D resource pool consists of resources for synchronization signal transmission, broadcast information transmission, discovery signal transmission, scheduling assignment transmission, payload data transmission, etc. FIG. 6 illustrates an example of the D2D resource components, as mapped to an illustrative time-frequency grid of resources.

Several of these components are described in more detail below. Note that the configuration is needed both for ProSe transmissions as well as monitoring for several of the components. Note also that discontinuous transmission and reception are supported by configuring the resources sparse in time and limited in frequency, as seen in FIG. 6.

Synchronization Signal—

A ProSe terminal may transmit a synchronization signal when i) no synchronization source has been detected, ii) it acts as a synchronization cluster head, i.e., as the synchronization source for a group of ProSe terminals, or iii) it relays a synchronization signal from a synchronization source. The synchronization signal configuration is also needed by D2D devices for monitoring for synchronization signal transmission by other devices.

Broadcast Information—

ProSe broadcast information, which is similar to system information normally transmitted from base stations, is transmitted by at least one ProSe terminal to one or more receiving UEs. Types of information that may be included in the broadcast information may include a transmitter ID, priority, group information relayed information, absolute time reference, etc. Note the relatively infrequent broadcast information scheduling shown in FIG. 6. The broadcast information resources can be either pre-configured or scheduled, or both, and information about the pre-configured resources are needed both for transmission and for monitoring.

Discovery Signal—

A discovery signal is transmitted by a ProSe terminal to enable other ProSe terminals to discover the UE. The discovery signal resources can be either pre-configured or scheduled, or both, and information about the pre-configured resources are needed both for transmission and for monitoring.

Scheduling Assignment—

The scheduling assignments (SAs) are transmitted to inform receiving terminals where to find payload data. As is the case with discovery resources, SA resources need to be selected with a consideration of monitoring costs. The scheduling assignment resources can be either pre-configured or scheduled, or both, and information about the pre-configured resources are needed both for transmission and monitoring. Also, the scope of the resources to be scheduled needs to be pre-configured.

Payload Data—

Payload data resources essentially encompass the remainder of the D2D resource pool, as seen in FIG. 6. As long as the resources can be addressed via SAs, it is possible to use rather flexible resources, scheduled when needed. A pre-configuration is needed to inform a transmitter about the resources generally available for payload data.

### Configuration Alternatives

As discussed above, there are several different possible approaches for transferring ProSE configuration information to mobile terminals. Several of these are discussed in more detail in this section. Note that some of these approaches can support the transferring of detailed entire configuration or the transfer of a configuration identifier or index, while others are more suitable for simply transferring a configuration identifier to the ProSe UE, which will then associate the transferred identifier with a particular one of several configurations stored internally.

Configuration Via SIM-Card—

One method to configure UEs without using an LTE network is to provide the information via a SIM card or equivalent, i.e., a hardware or software component that is installable in the device and that includes subscription information, information about terrestrial networks, and other operator information. This is a convenient method, e.g., in a scenario in which an IT manager or communications manager is responsible for distributing pre-configured mobile terminals to a group of emergency personnel or the like.

Configuration Via USB (Charger)—

Even if a SIM card is used to pre-configure a ProSe UE, the configuration provided may need to be to be updated from time to time. One situation when such reconfiguration would be needed is, for example, if a plane with first responders is sent from Sweden to the Philippines. The configuration for Sweden (from the SIM) would likely not work in the Philippines. Further, it may be recalled that after a recent typhoon in the Philippines there was no possibility to configure the UEs via an LTE network, since there was no network available for several days.

To address this situation, a rack with USB chargers capable of transferring a network configuration to the UE could be provided in the airplane or in a transport vehicle. Equipment on the rack would be “configured,” i.e., programmed, to supply appropriate country and network information to the UEs when the UEs are plugged in for charging.

Configuration Via Other Cellular RATs, Non-Cellular RATs, or Cellular RATs in Unlicensed Spectrum—

A third approach to configuring ProSe UEs is to use some other radio communication means. A typical UE will support multiple radio access methods, include support for multiple cellular RATs, but may also support transmission and reception in a non-cellular short range network or system, e.g., employing unlicensed spectrum bands. Some examples include: WiFi; short-range wireless technologies, such as Bluetooth, Zigbee, Z-Wave, UWB; and short-range/near-field communication technologies such as radio-frequency identification (RFID) technologies, near-field communications (NFC), dedicated short-range communications (DSRC), etc. Another possibility is that the configuration is performed using LTE radio access technology or other cellular RAT in an unlicensed band.

Configuration Based on Terminal Positioning—

According to this approach, a mobile terminal derives its position, for example by using a global navigation satellite system (GNSS), or some other means (for example based on reception of other signals), and the position is converted or interpreted as a configuration identifier, which is associated to an actual configuration. Note that a position, location, region, etc., can also be entered via any human interaction interface such as a keypad, touch screen, voice recognition system, etc. The entered information can be associated with one of several pre-configured D2D configurations, which is then retrieved, for example, from memory in the device and used for D2D operation. In a related approach, the mobile terminal's position can also be entered via the camera, where the position is indicated by a visual tag, bar code, QR code, etc. The position can also be communicated to the device as a way to encode a configuration identifier.

Configuration Via Camera—

Configuration alternatives using a camera extend beyond positioning. For example, the camera can observe a visual tag, bar code, QR code, etc., which directly conveys configuration information, such as a configuration identifier that can be used to select one of several pre-stored configurations.

Configuration Via Human Interaction Interface—

The configuration alternatives using human interaction interfaces (keypad, touch screen, voice recognition system, etc.) extend beyond the positioning-based approach. For example, the user interface can receive human input (keystrokes, touch gestures, voice commands, text entry, etc.) that directly conveys a configuration identifier.

Configuration Via Memory Card—

D2D configuration information can also be transferred to the ProSe UE via a memory card, which may transfer the entire configuration, or a configuration identifier to which the configuration is associated.

Embodiments of the presently disclosed techniques include the several methods described above, including the methods illustrated in the process flow diagrams of FIGS. 4 and 5, as well as variants thereof. Other embodiments include mobile terminal apparatus configured to carry out one or more of these methods. In some embodiments of the invention, processing circuits, such as the processing circuit 210 in FIG. 2, are configured to carry out one or more of the techniques described in detail above. Likewise, other embodiments may include mobile terminals include one or more such processing circuits. In some cases, these processing circuits are configured with appropriate program code, stored in one or more suitable memory devices, to implement one or more of the techniques described herein. Of course, it will be appreciated that not all of the steps of these techniques are necessarily performed in a single microprocessor or even in a single module.

FIG. 7 is another representation of a wireless device that is configured to carry out one or more of the techniques described herein. In this case, a wireless device 700 is represented as comprising several functional circuits, which may be referred to as “modules” or “units,” each of which may comprise all or part of one or more processing circuits and/or analog circuits. It will be appreciated that two or more of the functional circuits shown in FIG. 7 may be implemented using a single processing circuit. It will be further be appreciates that each of one or more of these functional circuits may be understood to correspond to a functional “module,” which may in turn correspond to program code that carries out the corresponding function when executed by a suitable processor.

Wireless device 700 thus includes a receiving obtaining module for obtaining configuration information for out-of-coverage device-to-device (D2D) operation, a determining module for determining that no wide-area wireless network is available for communicating, and an initiating module for initiating, in response to this determining, monitoring of resources or transmission using resources, or both, according to the obtained configuration information.

It will be appreciated by the person of skill in the art that various modifications may be made to the above described embodiments without departing from the scope of the present invention. For example, although embodiments of the present invention have been described with examples that reference a communication system compliant to the 3GPP-specified LTE standards, it should be noted that the solutions presented may be equally well applicable to other networks. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

In the present description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments have been described herein, with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) running on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Example embodiments of the techniques and apparatus described in detail above include, but are not limited to:

(a) A method, in a mobile terminal, comprising:
obtaining configuration information for out-of-coverage device-to-device (D2D) operation;
determining that no wide-area wireless network is available for communicating; and,
in response to said determining, initiating monitoring of resources according to the obtained configuration information.
   (b) The method of (a), wherein the obtaining is performed without the use of a wide-area wireless network.
   (c) The method of (a) or (b), wherein obtaining configuration information comprises obtaining one or more parameters defining out-of-coverage D2D operation.
   (d) The method of (a) or (b), wherein obtaining configuration information comprises obtaining a configuration identifier and wherein the method further comprises retrieving one or more D2D configuration parameters from one of two or more stored configurations, using the obtained configuration identifier.
   (e) A mobile terminal, comprising radio circuitry configured for communication with a wide-area wireless network and a processing circuit configured to control the radio circuitry, wherein the processing circuit is further configured to:
obtain configuration information for out-of-coverage device-to-device (D2D) operation;
determine that no wide-area wireless network is available for communicating; and,
in response to said determining, initiate monitoring of resources according to the obtained configuration information.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the scope of present inventive concepts. Thus, to the maximum extent allowed by law, the scope of the present inventive concepts are to be determined by the broadest permissible interpretation of the present disclosure.

1. A method, in a mobile terminal, comprising:
obtaining configuration information for out-of-coverage device-to-device (D2D) operation;
determining that no wide-area wireless network is available for communicating; and,
in response to said determining, initiating monitoring of resources or transmission using resources, or both, according to the obtained configuration information.

2. The method of claim 1, wherein obtaining configuration information comprises determining a position for the mobile terminal and determining the configuration information from the position.

3. The method of claim 2, wherein determining the position for the mobile terminal comprises determining the position using a global navigation satellite system (GNSS).

4. The method of claim 2, wherein determining the position for the mobile terminal comprises determining the position from information entered into the mobile terminal via a human interaction interface.

5. The method of claim 2, wherein determining the position for the mobile terminal comprises determining the position from information obtained via a camera associated with the mobile terminal.

6. The method of claim 2, wherein obtaining the configuration information comprises associating the determined position with one of a plurality of preconfigured D2D configurations.

7. The method of claim 1, wherein the obtaining is performed without the use of a wide-area wireless network.

8. The method of claim 7, wherein obtaining configuration information comprises receiving the configuration information via a connector interface on the mobile terminal.

9. The method of claim 8, wherein receiving the configuration information via a connector interface on the mobile terminal comprises receiving the configuration information from a Universal Serial Bus (USB) device.

10. The method of claim 7, wherein obtaining configuration information comprises receiving the configuration information via a wireless local-area network.

11. The method of claim 7, wherein obtaining configuration information comprises obtaining the configuration information from a subscriber identifier module (SIM) attached to or associated with the mobile terminal.

12. The method of claim 7, wherein obtaining configuration information comprises receiving the configuration information over a short-range wireless connection.

13. The method of claim 12, wherein receiving the configuration information over a short-range wireless connection comprises receiving the configuration information over a Bluetooth link.

14. The method of claim 7, wherein obtaining configuration information comprises receiving the configuration information using near-field communications (NFC) technology.

15. The method of claim 14, wherein receiving the configuration information using NFC technology comprises receiving the configuration information from a Radio-Frequency Identification (RFID) device.

16. The method of claim 7, wherein obtaining configuration information comprises receiving the configuration information by observing a visual representation of the configuration information, using a camera.

17. The method of claim 7, wherein obtaining configuration information comprises receiving the configuration information via human interface interaction.

18. The method of claim 7, wherein obtaining configuration information comprises receiving the configuration information via a memory card.

19. The method of claim 1, wherein obtaining configuration information comprises obtaining one or more D2D configuration parameters defining out-of-coverage D2D operation.

20. The method of claim 1, wherein obtaining configuration information comprises obtaining a configuration identifier and wherein the method further comprises retrieving one or more D2D configuration parameters from one of two or more stored configurations, using the obtained configuration identifier.

21. The method of claim 19, wherein the one or more D2D configuration parameters comprise one or more of the following:
details of resources allocated for D2D transmission;
identification of resources for one or more of synchronization signal transmission, broadcast information transmission, discovery signal transmission, scheduling assignment transmission, and payload data transmission;
discontinuous receive (DRX) settings and/or discontinuous transmit (DTX) settings;
incident manager identifiers; and
D2D group information.

22. A mobile terminal, comprising radio circuitry configured for communication with a wide-area wireless network and one or more other mobile terminals, and a processing circuit configured to control the radio circuitry, wherein the processing circuit is further configured to:
obtain configuration information for out-of-coverage device-to-device (D2D) operation;
determine that no wide-area wireless network is available for communicating; and,
in response to said determining, initiate monitoring of resources or transmission using resources, or both, according to the obtained configuration information.

23. The mobile terminal of claim 22, wherein the processing circuit is configured to obtain the configuration information by determining a position for the mobile terminal and determining the configuration information from the position.

24. The mobile terminal of claim 23, wherein the processing circuit is configured to obtain the configuration information using a global navigation satellite system (GNSS).

25. The mobile terminal of claim 23, wherein the processing circuit is configured to obtain the configuration information by determining the position from information entered into the mobile terminal via a human interaction interface.

26. The mobile terminal of claim 23, wherein the processing circuit is configured to obtain the configuration information by determining the position from information obtained via a camera associated with the mobile terminal.

27. The mobile terminal of claim 23, wherein the processing circuit is configured to obtain the configuration information by associating the determined position with one of a plurality of preconfigured D2D configurations.

28. The mobile terminal of claim 27, wherein the processing circuit is configured to obtain the configuration information without the use of a wide-area wireless network.

29. The mobile terminal of claim 28, wherein the processing circuit is configured to obtain the configuration information by receiving the configuration information via a connector interface on the mobile terminal.

30. The mobile terminal of claim 29, wherein the processing circuit is configured to receive the configuration information from a Universal Serial Bus (USB) device.

31. The mobile terminal of claim 28, wherein the processing circuit is configured to obtain the configuration information by receiving the configuration information via a wireless local-area network.

32. The mobile terminal of claim 28, wherein the processing circuit is configured to obtain the configuration information comprises by obtaining the configuration information from a subscriber identifier module (SIM) attached to or associated with the mobile terminal.

33. The mobile terminal of claim 28, wherein the processing circuit is configured to obtain the configuration information by receiving the configuration information over a short-range wireless connection.

34. The mobile terminal of claim 33, wherein the processing circuit is configured to receive the configuration information over a Bluetooth link.

35. The mobile terminal of claim 28, wherein the processing circuit is configured to obtain the configuration information by receiving the configuration information using near-field communications (NFC) technology.

36. The mobile terminal of claim 35, wherein the processing circuit is configured to receive the configuration information from a Radio-Frequency Identification (RFID) device.

37. The mobile terminal of claim 28, wherein the processing circuit is configured to obtain the configuration information by observing a visual representation of the configuration information, using a camera.

38. The mobile terminal of claim 28, wherein the processing circuit is configured to obtain the configuration information by receiving the configuration information via human interface interaction.

39. The mobile terminal of claim 28, wherein the processing circuit is configured to obtain the configuration information by receiving the configuration information via a memory card.

40. The mobile terminal of claim 22, wherein the processing circuit is configured to obtain the configuration information by obtaining one or more D2D configuration parameters defining out-of-coverage D2D operation.

41. The mobile terminal of claim 22, wherein the processing circuit is configured to obtain the configuration information by obtaining a configuration identifier and retrieving one or more D2D configuration parameters from one of two or more stored configurations, using the obtained configuration identifier.

42. The mobile terminal of claim 40, wherein the one or more D2D configuration parameters comprise one or more of the following:
details of resources allocated for D2D transmission;
identification of resources for one or more of synchronization signal transmission, broadcast information transmission, discovery signal transmission, scheduling assignment transmission, and payload data transmission;
discontinuous receive (DRX) settings and/or discontinuous transmit (DTX) settings;
incident manager identifiers; and
D2D group information.

43-63. (canceled)

64. A non-transitory computer-readable medium, comprising, stored thereupon, a computer program product comprising computer program instructions that, when executed by a processor in a mobile terminal adapted to communicate with a wide-area wireless network and one or more other mobile terminals, cause the mobile terminal to:
obtain configuration information for out-of-coverage device-to-device, D2D, operation;
determine that no wide-area wireless network is available for communicating; and,
in response to said determining, initiate monitoring of resources or transmission using resources, or both, according to the obtained configuration information.

65. (canceled)
